(19) United States
(12) Patent Application Publication
(10) Pub. No.: US 2008/0006649 A1
(43) Pub. Date: Jan. 10, 2008

(54) APPARATUS, METHOD, AND SYSTEM FOR PROMOTING CHARITABLE CONTRIBUTIONS IN ASSOCIATION WITH AN AUTOMATED MERCHANDISING MACHINE

(75) Inventors: PHIL MASTERS, DES MOINES, IA (US); JOHN BRUNTZ, DES MOINES, IA (US)

Correspondence Address: MCKEE, VOORHEES & SEASE, P.L.C., 801 GRAND AVENUE, SUITE 3200, DES MOINES, IA, 50309-2721, US

(73) Assignee: FAWN ENGINEERING CORP., DES MOINES, IA (US)

(21) Appl. No.: 11/668,839

(22) Filed: Jan. 30, 2007

Related U.S. Application Data
(60) Provisional application No. 60/763,271, filed on Jan. 30, 2006.

(51) Int. Cl. A47F 1/10; G06Q 30/00; G09F 27/00

(52) U.S. Cl. 221/154; 434/308; 705/10

(57) ABSTRACT

An apparatus and method for promoting voluntary contributions, such as to charitable causes, in association with an automated merchandising machine. The apparatus comprises a collection container with a lockable access door, the container adapted for mounting to an automated merchandising machine and including an opening through which coins or bills can be inserted. Information about the voluntary contribution cause can be displayed on the contribution box and/or the automated merchandising machine. Placement of the box is preferably chosen to promote voluntary contributions from customers of the automated merchandising machine customers. Preferably only the voluntary contribution cause has a key to the collection box.

### CROSS-REFERENCE TO RELATED APPLICATIONS

This application claims priority under 35 U.S.C. §119 of a provisional application Ser. No. 60/763,271 filed Jan. 30, 2006, which application is hereby incorporated by reference in its entirety.

### BACKGROUND OF THE INVENTION

A. Field of the Invention

The present invention relates to an automated merchandising machine such as vending machines, as well as charitable fundraising or other fundraising activities.

B. Problems in the Art

Most vending machine transactions involve a prospective purchaser making a decision to exchange value for a desired product from the vending machine. Commonly that “value” is cash. Frequently, the purchaser does not have exact amounts of cash and is returned cash change from the transaction. Therefore, many times there is a person with cash change on hand at the vending machine location.

Charitable organizations are usually highly dependent on a variety of funding sources, including charitable donations from individuals. Because charitable giving is so discretionary, and because it seems people are increasingly presented with more and more contribution solicitations and choices, there is increasing competition for each penny of charitable contributions.

Automated merchandising machines are usually a profit-motive business. Therefore, their modes and presentations are such that they promote and entice consumers to spend as much as possible on the merchandise in the machine. Many times that merchandise is branded. It can be famous, brand name products from a single source or a variety of manufacturers. Or it can be private labeled or otherwise branded. However, the vending machine business is an intensely profit-motive enterprise, usually driven by maximizing profits to the owner/operator of the machine. Also, customers of vending machines are usually driven by personal needs or desires.

On the other hand, charitable enterprises or causes are usually non-profit and seek voluntary contributions for use for the benefits of others. Thus, the vending machine world, so to speak, differs greatly from the charitable organization or causes world.

### SUMMARY OF THE INVENTION

The present invention is counter-intuitive in the sense that it promotes or attempts to induce automated merchandising machine customers to give some of their cash or credit to an entity or cause not directly related to the machine or its products, such as a charitable entity, cause, or activity. An apparatus according to one aspect of the invention comprises (a) a charitable contribution collection container, the contents of which are accessible only by a charitable organization to differentiate and keep separate the ownership of monies, which is (b) attached or closely associated with an automated merchandising or vending machine. The collection container can be placed in relatively close proximity to the change dispenser or coin or bill validator for the vending machine and has indicia clearly identifying the charity. Thus, the invention promotes donation of some of the money of the vending machine customer to the charity, in addition to purchase of merchandise from the machine. It does so by being at or in close proximity to (1) the physical location of the customer and (2) the time the customer is considering spending money or credit on personal consumables from the vending machine, and/or the customer has change or otherwise has made a spending decision.

Another aspect of the invention is the utilization of a receptacle for charitable contributions in association with an automated merchandising machine where the machine and the receptacle have correlated indicia regarding the charitable entity. In other words, the vending machine can have on it indicia, advertising, or even branded products that relates to or identifies a charitable organization. The contribution box, separately accessible by the charitable organization, can have correlated indicia to that on the vending machine. The combination achieves several things. It achieves cross-branding or sponsorship recognition between (a) the vending machine and its products (or the brands in, the owner/operator of, and/or the location of the vending machine) and (b) the charitable organization. Conversely, the charitable organization receives the benefit of sponsorship, brand-name recognition, and/or affiliation with the vending machine or its products (or the brands in, the owner/operator of, and/or the location of the vending machine).

A still further aspect of the invention is more subtle. The invention promotes the placement of vending machines in locations traditionally difficult to place them, or provides a new strategy for opening up new locations for vending machines. A charitable organization is more likely to allow a vending machine on its premises if there is a co-branding relationship between it and the products in the machine. Or, an independent business or other entity may be more likely to allow placement of a vending machine on its site if associated with a charitable organization, especially one that it or its employees or customers approve of. The invention allows this type of synergy.

### BRIEF DESCRIPTION OF THE DRAWINGS

FIG. 1 is a front elevation view of an exemplary embodiment of the present invention.

FIG. 2 is an enlarged front view of the charitable contribution box of FIG. 1.

FIG. 3 is a front perspective view of the charitable contribution box of FIG. 2 with its door open, showing its interior, and also showing, in exploded form, how it can be attached to a vending machine.

FIG. 4 is a block diagram schematic of an optional circuit that could be used with the embodiment of FIG. 1.

FIGS. 5A and B illustrate an alternative exemplary embodiment of the present invention.

FIG. 6A is a front perspective view of an alternative embodiment of a charitable contribution box and FIG. 6B is a block diagram schematic of an optional circuit that could be used with the embodiment of FIG. 6A.

FIG. 7 is a front perspective of a still further optional feature that can be associated with the charitable contribution box of FIG. 2.

FIG. 8 is a perspective view of an alternative embodiment of a collection box according to the present invention.

FIG. 9A is a reduced-in-scale exploded view of the collection box of FIG. 8.

FIG. 9B is an isolated view of several pieces of FIG. 9A packed together efficiently for shipping inside the main box of FIG. 9A.

FIG. 10 is an isolated enlarged view of the main box part of FIG. 9A.

FIG. 11 is an isolated enlarged view of the main part of a lockable front door for the front of the box of FIG. 10.

### DETAILED DESCRIPTION OF THE EXEMPLARY EMBODIMENT OF THE INVENTION

A. Overview

For better understanding of the invention and its aspects, a specific example of one form the invention can take will now be described in detail. It is to be understood that this is but one example and does not limit the forms the invention can take. Variations obvious to those skilled in the art are included within the invention.

B. Context of the Exemplary Embodiment

This example will be described in the context of a conventional vending machine or automatic merchandizing equipment such as one which provides a variety of pre-packaged products of different brands, and in the context of a charitable organization (here, as an illustrative example, the Animal Rescue League, a non-profit animal shelter). However, it is to be emphasized that the invention relates to any type of automated vending or merchandising machine and any charitable organization or fund-raising activity. Further, as described later on, the invention can also apply to analogous or related situations.

C. Apparatus

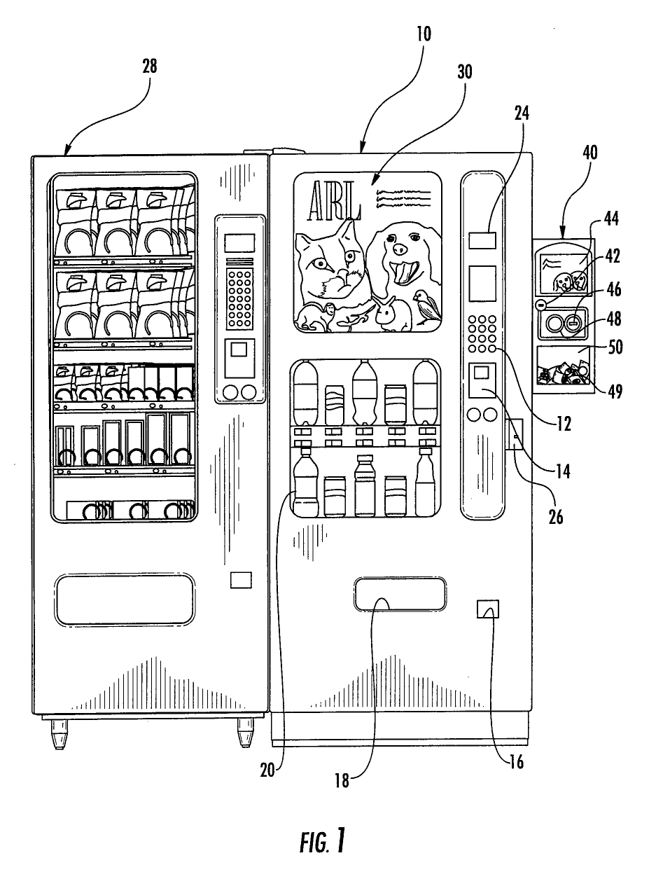

The exemplary embodiment is shown in attached FIG. 1. A master or stand-alone vending machine (e.g. snack, coffee, or beverage machine) 10 is conventional and has a conventional coin receiver and bill validator (see reference numeral 12), a customer input key pad 14, a change dispenser 16, and a product dispenser 18. Additionally, the front of machine 10 includes a window 20 through which examples of available products and their selection numbers or letters is presented to the consumer. Here a variety of beverages of different container shapes and sizes and different manufacturing brands are presented to the customer along with the selection number and prices.

Furthermore, the face of vending machine 10 has space 30 where a display with indicia identifying the Animal Rescue League is applied to the machine 10 (e.g. signage of thin plastic with a clear plastic laminate overlay that fits onto the vending machine or into or behind a window in the vending machine). The area is relatively large and prominent. It is in close proximity with the display window 20 of the brand name products. Machine 10 also has a small display 24 that is programmable to display different letters or symbols to the consumer. It also has a key lock 26 allowing the vending machine owner or operator to access the money, products, and components inside machine 10.

In this example a second vending machine 28 is side-by-side with machine 10. Here machine 28 has most of the attributes of machine 10 but is a “slave” machine to “master” (or stand alone) machine 10. The main differences are that it displays and dispenses snacks and candy as opposed to beverages. It also does not have a display area for the charity, but the side-by-side combination and the position and size of the indicia 30 for the Animal Rescue League on machine 10 makes it relatively close to the display window of machine 28. As is well known in the art, machines 10 and 28 can be in operative communication with each other. For example, machine 10 may have a master controller for both machines 10 and 28; thus the “master-slave” arrangement. On the other hand, each machine 10 and 28 could be totally independent.

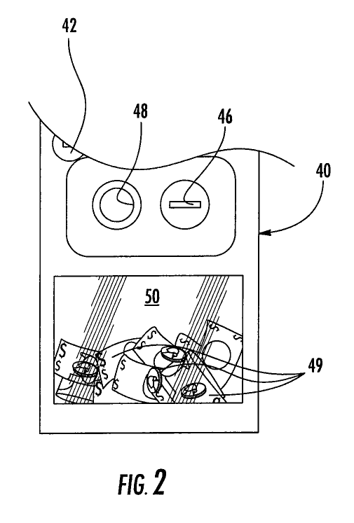

A charitable contribution box 40 is attached along the side of vending machine 10. In this example it is bolted from the inside through the wall of machine 10. Box 40 has the following attributes:
a. It has a key lock 42 that is operated by a separate key from that of the key locks of machines 10 and 28. The key would be given to the charitable organization, here the Animal Rescue League, and not be accessible by any other person or entity.
b. On its front is an area 44 with indicia that is correlated to the charity. Here the indicia identifies the Animal Rescue League but also has text and pictures or graphics that solicit a contribution. This area 44 is at roughly eye level and at roughly the same level as the indicia space 30 identifying the charity on vending machine 10.
c. Box 40 additionally has one or more openings through which can be placed cash bills or coins. As can be seen in box 40, coins can be inserted through slot 46 and would fall into the interior of box 40. Bills can be rolled into a tube shape and slid through small circular opening 48. For that matter, checks could also be inserted. The openings for 46 and 48 are, however, too small for fingers or hands to be inserted.
d. Additionally, box 40 has a window 50. This allows people to view how much cash has been inserted into box 40. One option is that a picture or decal of actual or simulated bills and/or coins (see reference number 49 in FIGS. 1 and 2) could be applied to the lower half of window 49. This, what is sometimes called an “impulse view”, could help induce persons to notice the solicitation and give to the charity.

Box 40 can be made of sheet metal and window 50 of Plexiglas of durability similar to that used in machines 10 and 28. The key lock can be a conventional lock. Preferably it would be substantially durable to resist at least some vandalism or attempts to pry open.

Additionally, preferably box 40 would be placed at a height that qualifies under American Disability Act suggestions (e.g., is at a level that someone in a wheelchair could reach, for example, no more than about 54 inches from the floor).

D. Methodology

As can be appreciated from the foregoing, one method according to the present invention is promotion of giving to a charity, here the example being the Animal Rescue League. Placement of box 40 right on machine 10 provides not only promotion of the charity but immediate proximity to the handling of cash. Even if a consumer only gives change from vending machine 10 or 28 to box 40, every little bit counts. As is well known, small contributions by a large number of people can add up to significant amounts. By having box 40 at machine(s) 10/28, the promotion of even a small amount of giving is achieved based upon the close proximity to the time the vending machine customer is dealing with his/her purchase or change from it, as well as close proximity in location of a place or receptacle to provide the charitable contribution. In combination, this provides a creative opportunity to promote and induce charitable giving. It creates a type of “impulse buying” environment for the charitable giving because both money and a place to put it are at hand (there is no requirement of mailing in a contribution or going to a different place to contribute). Box 40 and the promotional indicia are also at hand all the time, and a live person is not needed to assist in the charitable promotion, except to periodically retrieve contributions by going to box 40 and, with an authorized access key, opening it, removing the contributions, and re-locking it.

Another aspect of the methodology according to the invention is that the vending machine operator does not have access to box 40. It is controlled by the charitable organization or its designee by having a separate lock and key. Therefore, the burden of and responsibility for maintenance, retrieval of contributions, accounting for contributions, etc. can be placed on the charitable organization or its designated agent. Conversely, the vending machine owner/operator is absolved of these responsibilities and burdens.

A still further aspect of this invention is the co-branding concept. A vending machine owner/operator goal is getting as much money as possible through vending sales to customers, and a charitable entity goal is to get as much charitable contribution as possible. By indicia 30 on the vending machine correlated to indicia 44 on the collection box 40, synergy between those two goals is promoted. Consumers may be induced to give contributions to that charity at or around the moment of purchase from the machine(s) 10/28. But consumers may also be prompted to more frequently purchase from the machine if it indicates affiliation with that charity. Thus, this type of “co-branding” has two-way benefits, not only for the charity but also the owner/operator of the vending machine(s).

Also on the business side, the co-branding can promote access to and permission for placement of machines and collection boxes in what might previously have been areas or locations where permission was not given. For example, a retail business that otherwise does not allow placement of a vending machine on its site may do so because the business likes the idea of promoting the charity.

Also, it is possible that a charity could agree to exclusively use box 40 with a particular manufacturer's or owner/operator's automatic merchandising equipment.

At its broadest level, the invention does not require indicia or information about the charity on vending machine 10. It could simply be on collection box 40, or attached to, placed in association with, or incorporated at or near box 40 and/or machine 10. The proximity of a receptacle for receiving contributions for the charity could alone induce contributions. However, having correlated indicia related to the charity on the vending machine itself, as well as box 40, can have subtle advantages as indicated above.

It can therefore be seen that the above-described embodiment is a relatively inexpensive and non-complex self-contained collection box that can be bolted or otherwise securely attached to the side of an automated merchandising machine. It is separately keyed so that a designated party can control access to its contents. In one aspect it presents what might be considered the incongruent concept of soliciting charitable donations at a normally for-profit merchandising machine.

E. Options And Alternatives

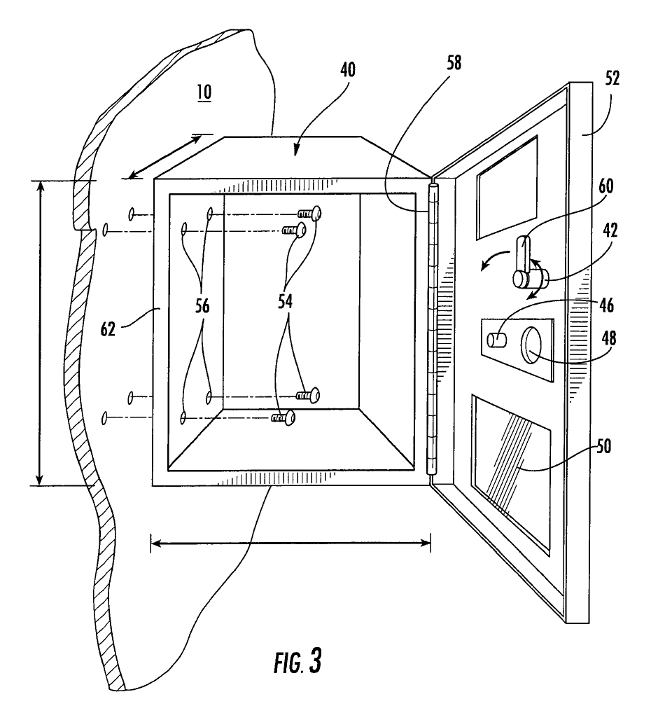

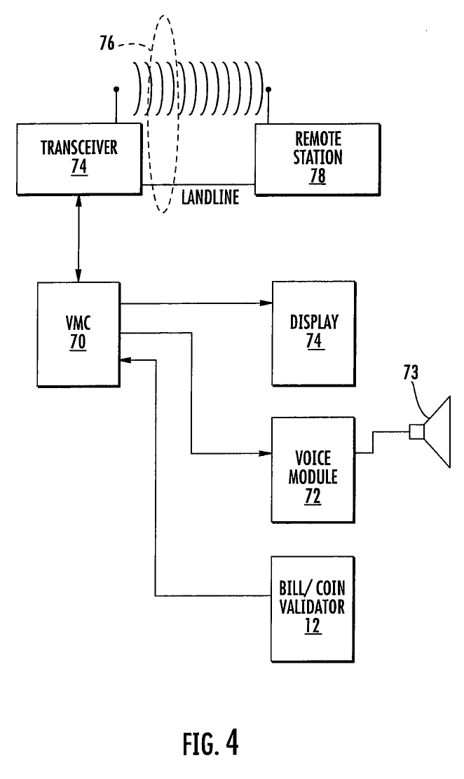

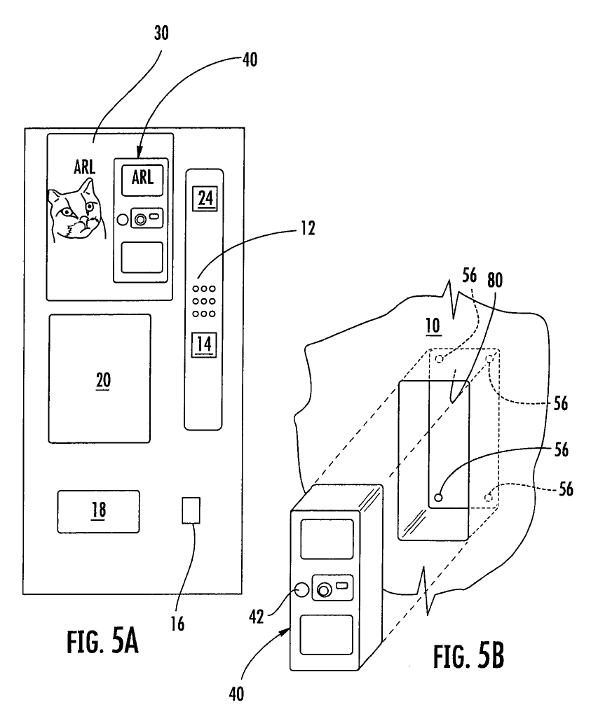

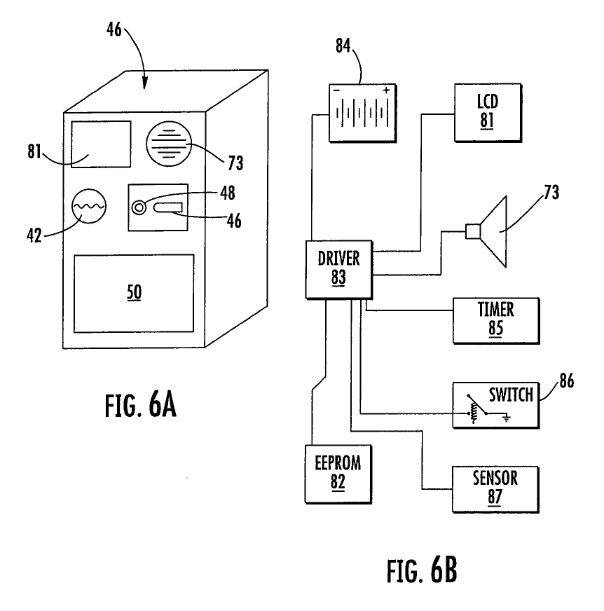

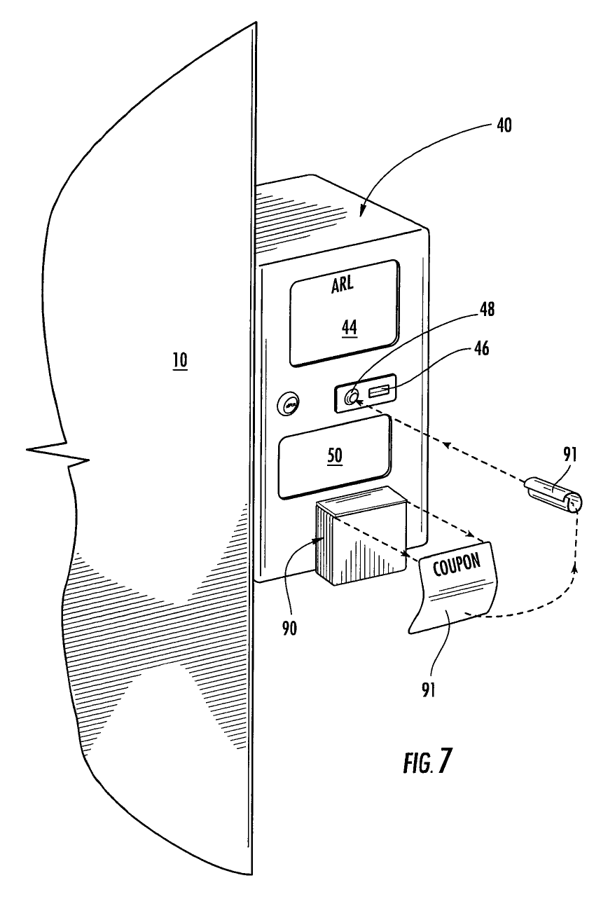

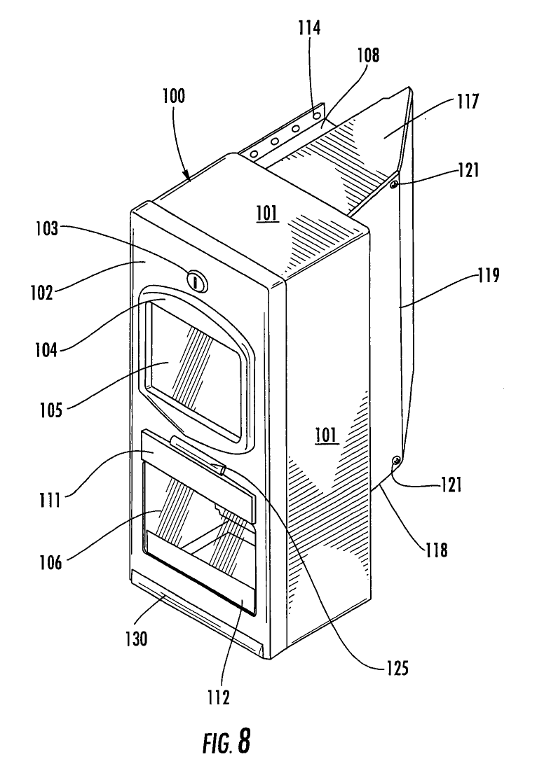

As will be appreciated, all sorts of variations and alternatives are possible with the general concept of the invention. Variations obvious to those skilled in the art will be included with the invention. The invention is not limited by the specific examples given herein. However, to give additional ideas of possible embodiments under the scope of the invention, some will be described below:
1. The specific size, shape and configuration, materials, and arrangement of collection box 40 can vary. For example, collection box 40 in FIG. 1 is approximately 18 inches in height by 8 inches in width by 6 inches in depth (see FIG. 3), and made of sheet metal that is painted. Other sizes, shapes, materials, or configurations are possible, of course. There could be more than one box 40 in stacked relationship or side by side. Or there could be multiple slots or openings for coins, bills, or checks in one box 40 but for a plurality of charitable entities or causes. The arrangement of the charitable organization indicia, the configuration of the receivers for bills and coins, and the window (which is optional) can vary. FIGS. 8-11 illustrate details of an alternative collection box 40, and will be described later.
2. In the embodiment of FIG. 1, box 40 is set back several inches from the front plane of machine 10, in other words behind the vertical plane of the front of the door of machine 10. For example, it can be set back three inches or so to avoid interference with opening or closing the front door of machine 10, or contact with people. However, it could be placed in different orientations relative to machine 10.
3. In the exemplary embodiment, box 40 is intended for placement on vending machines that are not a high risk of vandalism or attempted theft. Box 40 could be substantially more ruggedized if it was desirable for higher risk areas.
4. FIG. 3 shows one optional structure for box 40. A door 52 is pivotable on hinge 58 at the front of box 40. Screws or bolts 54 are used to pass through holes 56 in a side of box 40 to mount box 40 directly to a side of a vending machine. A conventional key lock arrangement has a locking arm 60 that catches on a lip of box 40 to lock door 52 in place or to unlock door for collection of what is inside box 40. As previously described, coin slot 46 and round opening 48 (for rolled up bills or checks) are sized to allow passage of those types of contributions but to disallow access by hands or fingers to the interior when locked.
5. It should be appreciated that box 40 could also be built into machine 10 or partially built-in. For example, a recessed receiver could be built into the front of machine 10 and box 40 slid into the receiver and somehow fixed into place. Box 40 would still have the separate key lock but it would give a more integrated look. An example is illustrated at FIGS. 5A-B. FIG. 5B shows a recess or receiver 80 built into the front of vending machine 10 that is sized to mateable receive a box 40 like that shown in FIG. 1. Box 40 could be bolted to machine 10 through openings 56 in the back of recess 80, or otherwise held or fixed in place. Box 40 would still have a separate lock and other features of box 40 of FIG. 1. It would differ from FIG. 1 in that it is, and looks more, integrated with vending machine 10 (see FIG. 5A). However, the charity would still have a separate key to box 40.
6. A still further embodiment might be simply to build in the indicia, bill and coin receiver, and window like on the front of box 40 into the front door of machine 10 and mount behind it a coin and bill box that is separately lockable. The machine operator would have access to open the vending machine door but could not gain access to the contribution box without a separate key.
7. A still further option would be to somehow tie in box 40 to the electronic controller of machine 10. One example is as follows. There are well-known ways to electronically sense each coin or bill (e.g., coin value sensors and bill validators). There could be a communication of the amount submitted to box 40 made to the already existing controller of machine 10. A record could be kept of real time contributions that could be made available to the charitable organization. Furthermore, a running total of contributions to a number of these boxes 40 around a geographic area could be kept and communicated (e.g. automatically over a communications network) to the charity so it knows now much has been collected at any time (e.g. each day or week). A machine 10 could also give notice to the charitable organization that it is time come and unload a box 40 if it gets filled (by some sensor mechanism) or based on exceeding a certain threshold amount of monetary value. Such communication could be wired or wireless or a combination of both.
8. Another option would be as follows. Machine 10 could display to a vending customer a question asking whether they want to contribute to the charity before, during, or after making a selection. But still further, one embodiment of the invention could leave out box 40 and rather machine 10 would query the customer whether they want to contribute to the charity and, if so, the customer could deposit (or charge to a credit card) in the machine 10 an amount they want to contribute. The master controller could make an accounting of the same and then, from the gross cash input in the machine 10, distribute the appropriate amount to the charity.
9. A still further option would be to include either a voice-activated or sound activated component to box 40. It could also be mechanically activated. For example, if a sensor detects a contribution event at box 40 (e.g. the insertion of a coin or bill into box 40), an audible and/or visual message could be presented to the customer, such as “thank you for your contribution”, or “please visit us”, etc. On the other hand, if a sensor detects an event at or near machine 10 (a sound, such as a human voice or footsteps, or deposit of a bill or coin in machine 10), an audible and/or visual message could also be activated which solicits contribution from the customer, such as “Please consider giving to Animal Rescue League”. It does not have to be purely visual or purely audible. It could be a combination of visual and audible.
10. The indicia on box 40 could vary over time. It could be designed with a changeable POM (Point of Message) feature. One specific example would be some sort of programmable display, either battery powered or separately electrically powered, built into box 40 or machine 10 or 28. FIG. 4 diagrammatically illustrates a display 24 (e.g. LCD) hooked up to a vending machine controller (VMC) 70 in vending machine 10. A programmable voice module 72 stores digital sound files (e.g. .WAV files like “Please consider donating to the Animal Rescue League”, or “Place your change in the box to help stray dogs and cats in your community”, or sounds such as a barking dog). VMC 70 would know when change is given to a customer and could instruct a sound file to be played through speaker 73. Simultaneously, a text message, picture, or graphic could be displayed on display 24. Such options would be intended to further promote or induce charitable contributions. It would be possible to simply ask a vending machine 10 customer via a message on display 24 whether they would like to contribute to a charity and allow the customer, through an existing keypad 14 (FIG. 1) to accept or decline, and to either contribute any change from the vending machine transaction or input a specified amount. The VMC could keep track of this. Also, by means known in the art for other purposes, a transceiver 74 could be in two way communication with a remote computer 78 via land-lines or wireless or a combination of both (see reference numeral 76). The VMC could keep track of charitable contributions elected by the customers, account for them, and then send that information to a central location (or even to the charity) so that an accounting can be made between the money for vendible items and the money contributed to the charity. It could also change an audible or visual message to continuously update how much money has been collected by the charity through use of box 40.
11. Any of a variety of messages or displays could be used on a display 24. If capable, display 24 could even display video or pictures as well as text or other graphics. In other words, it could display the identical indicia shown in FIG. 1 but as a pixilated image on a color LCD. This also allows the indicia to be changed. In other words, one day it could display indicia of one charity; the next a different one. Or it could display different things about the same charity. For example, it could have the display of FIG. 1 at one moment. The next it could flash some different message or solicitation. It could even display periodically the amount of money collected or the collection goal, etc. LCD displays of this type and size are commercially available.
12. Another option is illustrated in FIGS. 6A and B. A speaker 73 and LCD 81 could be incorporated into box 40. A commercially available, battery-powered (reference number 84) electronically erasable programmable read only memory (EEPROM) 82 could be connected to a driver or microprocessor 83 also in box 40. By push of a button 86, or at certain pre-determined times or intervals controlled by timer 85, or by some sensor (e.g. photocell 87 or motion detector) which senses when a person is near, driver 83 could activate an audible message from a digital sound file in EEPROM on speaker 73 and/or generate some display on LCD 81. The system of FIGS. 6A and B could be entirely housed in box 40 and would not have to rely on components of vending machine 10. It could therefore be controlled and maintained by the charitable entity and could be moved from vending machine to vending machine.
13. Likewise, indicia on machine 10 or 28 could vary in size, shape, and content. The indicia of machine 10 or 28 could also be changeable. It could have a frame to interchange paper or plastic sheet indicia such as shown in FIG. 1. It might also have some sort of a digital display as described with regard to box 40. Note also that an existing digital display 24 contained in conventional machine 10 could be programmed to display messages or symbols that relate to the charitable contributions or charity.
14. Another alternative would be to optionally include with box 40 other things. As illustrated in FIG. 7, for example, a pad 90 of tear-away coupons 91 (or fill-in sheets for a contest or drawing) could be attached or fixed to box 40. Instead of a charitable contribution, the vending machine customer could tear off the drawing sheet 91, fill it out, and insert it into box 40 through round opening 48. A drawing could be held at periodic times and reward the winner in some fashion. The indicia or display on box 40 and/or machine 10 could promote the drawing, raffle, or contest. The tear off sheets could also be for suggestions, comments, questions, and the like. Other possibilities are ballots, registrations, entry forms, and the like.
15. Another example would simply be a collection box 40 for a dedicated fund instead of a charity purse. For example, funds for an office party or a going away gift for a co-worker could be collected at the vending machine at the site of the office and its workers. It might also be used by civic groups (e.g. public libraries), schools, political parties, or other entities or organizations.

FIGS. 8-11 illustrate a slightly different embodiment of collection box 40. This is another example that the specific configuration of the invention can vary but can retain consistent aspects and advantages. This alternative collection box, designated in FIGS. 8-11 as box 100, is similar to box 40 previously described. It bolts or rigidly attaches to the side of an automatic merchandising machine. It has a separately keyed lock. It allows paper currency, checks, and coins to be inserted and stored. It has a window where the public can view the contents of the interior. It has a display where indicia or advertising about a charity or other organization can be displayed. The main differences from box 40 are as follows.

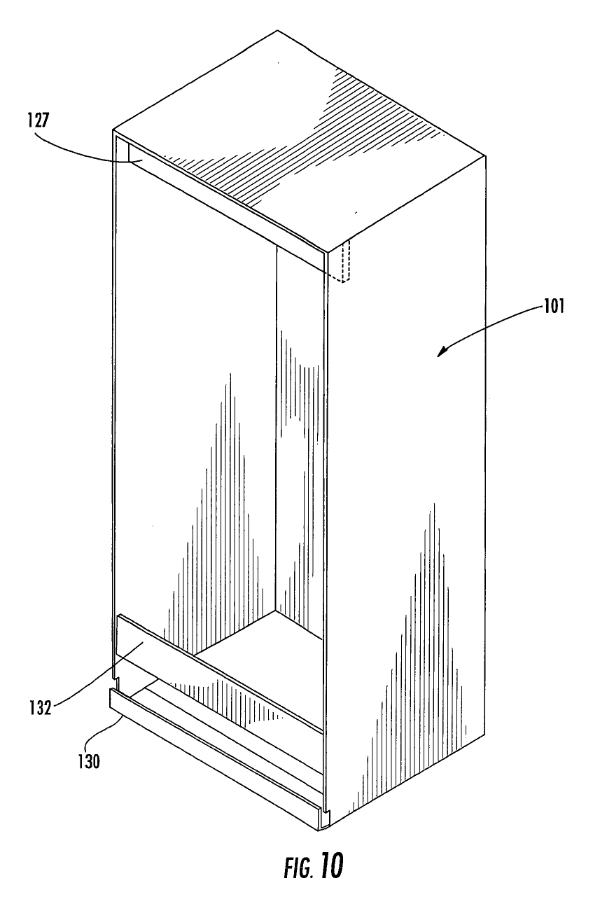

As can be seen by viewing FIGS. 8-11, box 100 includes a basic box 101 (FIG. 10). A removable front door 102 has a lower edge that can slide behind ledge 130 of box 110. A lock 103 at the opposite or top of removable front door 102 can be configured to lock front door 102 to box 101 (the locking arm would latch behind lip 127 in box 101). If lock 103 is unlocked with appropriate key 113, it will be released so that door 102 can be moved outward away from box 101 and then lifted out of channel 130 to gain access to the interior of box 101. An internal support 132 can be mounted in box 101. Alternatively, the lower edge of door 102 can be hinged to box 101.

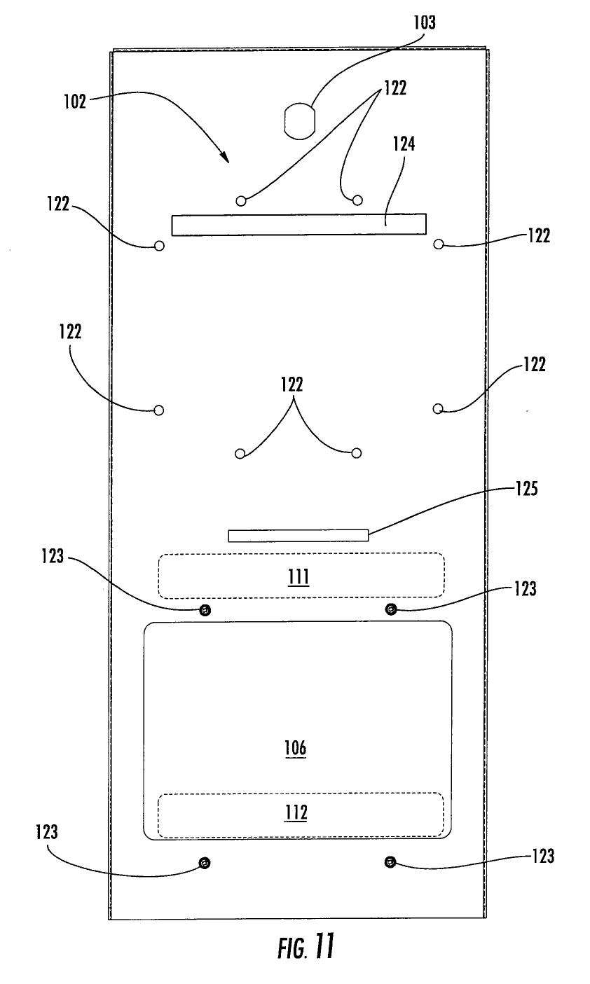

FIG. 11 illustrates a starting frame 102 for the front door before it is assembled into a final front door assembly such as shown in FIG. 8. Keyed lock 103 can be mounted securely in the upper opening marked 103 in door frame 102. A bezel 104 can function as a frame for point of purchase window 105 which would clamp a point of purchase graphic or advertisement 107 to the front of door 102. Bezel pins of bezel 104 could fit into openings 122 in door 102. This would allow it to be secured but removable for changing the graphic insert 107. A lower window 106 can be screwed or bolted through holes 123 at the bottom of door 102 from its inside (to prevent removal from the outside). A decal 112 can be applied at the bottom of window 106. As mentioned previously, the decal could be a picture or illustration of dollar bills and coins to promote giving and draw person's eyes towards window 106.

A decal 111 can be applied directly above window 106 and directly under a narrow slot 125 through which currency, checks, or coins could be deposited but being of a size through which fingers or instruments could not practically remove the contents. A small hood could be punched or formed over the slot for further protection. Alternatively, a small baffle or lip could extend inwardly from slot 125 to deflect money or coins down.

An elongated foam gasket tape 116 could be adhered along the top inside of door 102 and aligned with the top edge of box 101 to deter rattling between those parts or otherwise allow some tolerance to achieve a tight locking fit.

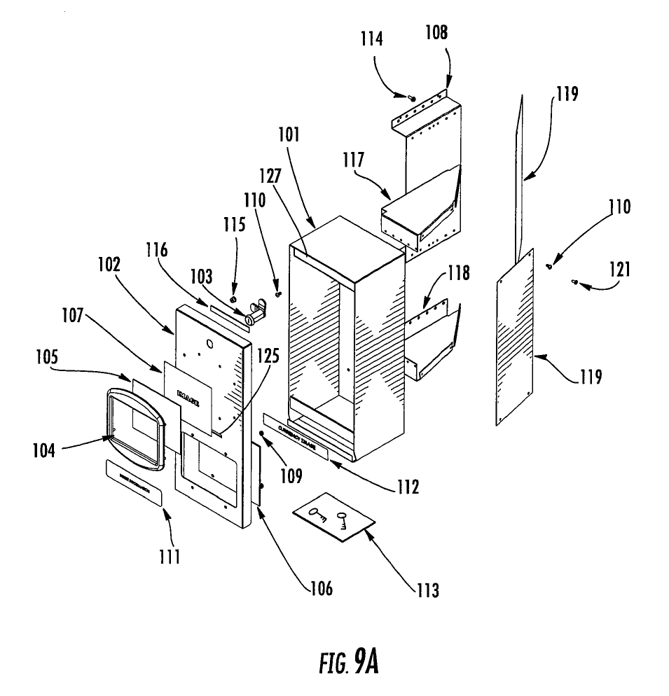

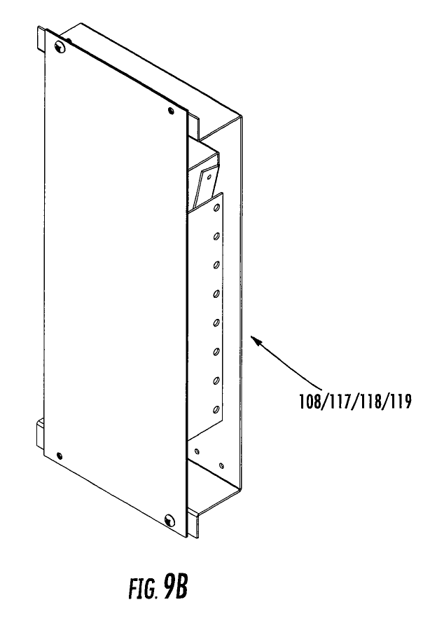

In this instance, a sheet metal box framework is connected to the back of collection box 101 and constitutes the method of mounting box 101 to the merchandising machine. As shown in FIG. 9A, the sheet metal box framework comprises a main metal mount 108 has openings for bolts or screws 114 to attach to the side of a vending or automated merchandising machine. Gussets 117 and 118 would attach to the back of donation box 101 and to mount 108. A two section back cover 119 would screw or bolt to gussets 117 and 118 to complete the box frame shown in FIG. 8. This would allow box 100 to be positioned anywhere along the side of an automated merchandising machine. As shown in FIG. 8, it allows it to be positioned so that box 102 is spaced laterally an inch or two from the side of the automated merchandising machine, if desired.

FIG. 9B shows, that for shipping the back mounting frame 108, top and bottom gussets 117 and 118, and the back cover pieces 119 could be combined in a compact form to reduce shipping size. They are sized so that, when packed like FIG. 9B, they can all fit into the interior of box 101. Towards that end, the entire donation box assembly 100 could be compactly shipped as a kit, including one or more keys 113. Instructions could accompany the kit and allow a charitable organization or other entity or organization to purchase the kit and install it.

Other options, forms, or embodiments are possible. The foregoing is intended simply to give additional ideas on embodiments options and alternatives that could be included within the invention.

What is claimed is:

1. An apparatus for promoting voluntary contributions in association with an automated merchandising machine with a lockable door, comprising:
a. a collection container having a interior space adapted for mounting to an automated merchandizing machine;
b. at least one of coin or bill opening into the interior space;
c. a door which is lockable by a key separate from the automated merchandising machine, the door when locked disallowing physical access to the interior space.

2. The apparatus of claim 1 further comprising indicia on the container identifying a fund raising cause.

3. The apparatus of claim 2 wherein the fund-raising cause comprises a charity.

4. The apparatus of claim 1 further comprising a window to view the interior space.

5. The apparatus of claim 2 in combination with an automated merchandising machine.

6. The apparatus of claim 5 further comprising indicia on the automated merchandising machine correlated to the fund-raising cause.

7. A method of promoting voluntary contributions in association with an automated merchandising machine comprising:
a. placing a separately lockable contribution container in close proximity to or on the automated merchandising machine;
b. placing correlated indicia related to a fund-raising cause on both the container and the machine.

8. The method of claim 7 further comprising marketing to third parties placement of the machine and box because of affiliation with the fund-raising cause.

9. The method of claim 7 further comprising promoting immediate contribution to the fund-raising cause from customers of the machine.

10. An automated merchandising machine having a front display area, a bill or coin validator, and a change return comprising:
a. the display area on the vending machine including indicia related to a fund-raising cause;
b. a fund-raising collection box mounted on the merchandising machine comprising a separately lockable access door and a bill or coin deposit slot.

11. The apparatus of claim 10 wherein the contribution box is attached to an exterior side of the merchandising machine.

12. The apparatus of claim 10 wherein the collection box is matingly inserted in a recess in the merchandising machine.

13. The apparatus of claim 10 wherein the collection box is installed behind a surface of the merchandising machine but with the coin or bill slot exposed to the exterior of the merchandising machine.

14. The apparatus of claim 10 wherein the collection box is in relatively close proximity to the bill or coin validator.

15. The apparatus of claim 10 wherein the collection box is in relatively close proximity to the change return.

16. The apparatus of claim 10 further comprising a display area associated with the collection box, the display area including indicia related to the fund raising cause.

17. The apparatus of claim 10 further comprising an electronic coin or bill sensor associated with the coin or bill slot of the collection box, the coin or bill sensor creating an output signal correlated to the amount of coinage or currency bills inserted in the collection box.

18. The apparatus of claim 17 wherein the signal is used to count total contributions to the contribution box.

19. The apparatus of claim 18 wherein the total contributions to the contribution box are displayed on a display, communicated to personnel or representatives of the fund raising cause, or stored.

20. The apparatus of claim 19 further comprising a plurality of contribution boxes with bill and coin sensors associated with a plurality of automated merchandising machines, wherein the signals from each bill or coin sensor are communicated to a central source.

21. The apparatus of claim 10 further comprising a sensor to sense proximity of a person to the collection box and automated merchandising machine and outputting a signal on that event.

22. The apparatus of claim 21 wherein the signal is used to actuate one or more of an audible or visual message.

23. The apparatus of claim 22 further comprising a programmable memory in which is stored a variety of audible or visual messages which are selectable by programming.

24. A kit for promoting voluntary contributions associated with an automated merchandising machine comprising:
a. a collection container with a door lockable by a key;
b. one or more keys;
c. mounting hardware adapted to mount the box to an automated merchandising machine;
d. a point of purchase area on the box adapted for display of information related to promoting voluntary contribution.

25. The kit of claim 24 wherein the display area is adapted to include information related to a charitable cause.

26. The kit of claim 24 further comprising a display related to promotion of voluntary contribution adapted for placement on an automated merchandising machine.

27. A method of marketing the placement of automated merchandising machines comprising:
a. identifying a target customer for placement of an automated merchandising machine;
b. proposing placement of an automated merchandising machine in combination with a collection box for a voluntary contribution cause of the target customer's choosing;
c. placing an automated merchandising machine at the proprietor's location and installing a voluntary contribution collection box, separately accessible by the voluntary contribution cause, with the automated merchandising machine, and displaying advertising of the voluntary contribution cause.

28. The method of claim 27 wherein the voluntary contribution cause is a charitable cause.
